(19) United States
(12) Patent Application Publication
(10) Pub. No.: US 2017/0136594 A1
(43) Pub. Date: May 18, 2017

(54) CIRCULAR CUTTING BLADE HAVING INDICIA CORRESPONDING TO BLADE DIAMETER AND CUTTING ASSEMBLY

(71) Applicant: JOE SOLBERG, INC., TYRONE, GA (US)

(72) Inventors: Joseph R. Solberg, Peachtree City, GA (US); Aaron Richard Bloy, Peachtree City, GA (US)

(21) Appl. No.: 14/943,087

(22) Filed: Nov. 17, 2015

(51) Int. Cl. B23Q 17/09; B24B 3/46; B26D 1/157

(52) U.S. Cl. CPC B23Q 17/0995; B26D 1/157; B24B 3/46

(57) ABSTRACT

A circular cutting blade includes a circumferential cutting edge defined by a diameter and a vertically-oriented planar surface that includes indicia thereon. The indicia are a plurality of values corresponding to measured diameters of the blade after the blade is re-sharpened.

### BRIEF DESCRIPTION OF THE DRAWINGS

The apparatus is described with reference to the accompanying drawings. In the drawings, like reference numbers indicate identical or functionally similar elements.

FIG. 1 depicts a cutting assembly in which an exemplary circular cutting blade is installed;

FIG. 2 is a elevational view of an exemplary circular cutting blade; and

FIG. 3 is an isolated view of a blade depth adjustment mechanism.

### DETAILED DESCRIPTION

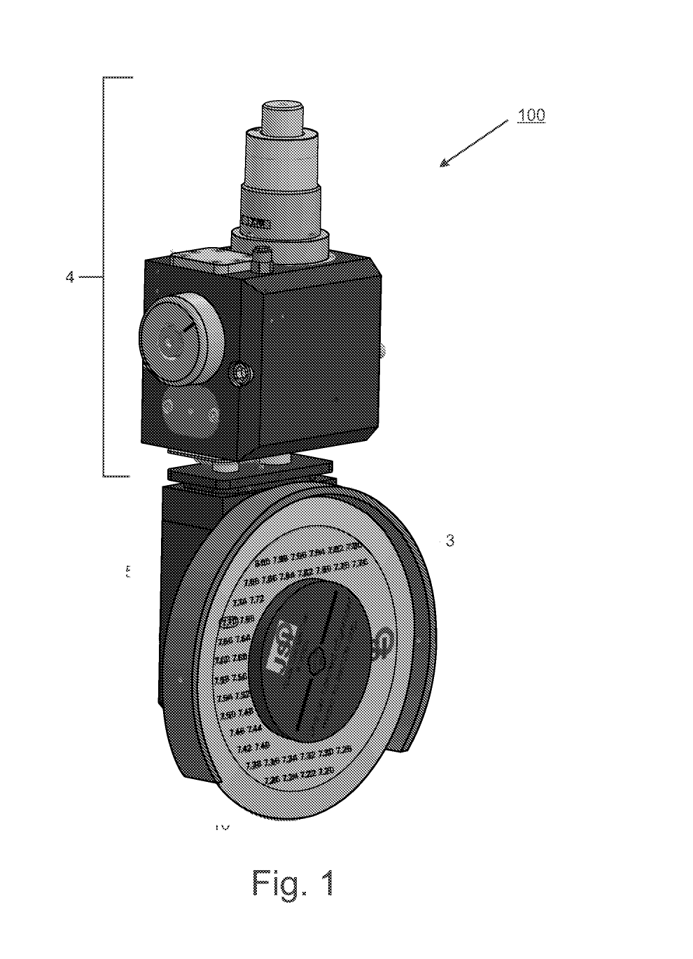

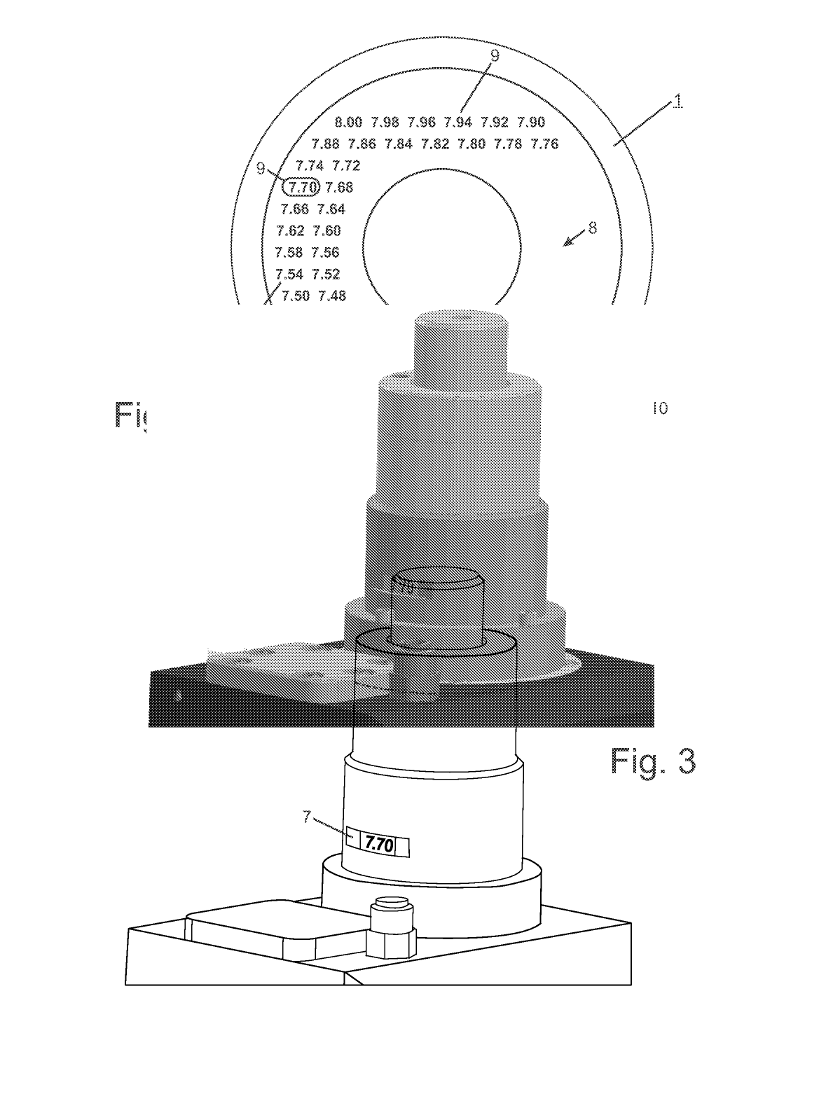

The apparatus and its advantages are best understood by referring to FIGS. 1 through 3 of the drawings. The elements of the drawings are not necessarily to scale, emphasis instead being placed upon clearly illustrating the novel features and principles of operation. Throughout the drawings, like numerals are used for like and corresponding parts of the various drawings.

A cutting assembly 100 is provided for cutting material (not shown) that is fed to the assembly in, for example, a cutting process step. The assembly 100 includes a circular cutting blade 1 mounted on an axle 2 that is driven by a motor 5. A cutting guard 3 at least partially surrounds the blade 1. A vertical adjustment assembly 4 is operatively coupled to the axle 2 to allow the blade to be vertically adjustable. The adjustment assembly comprises a rotating adjustment knob 6 mechanically or electro-mechanically coupled to a readout 7 that displays the diameter of the blade 1. Rotation of the knob 6 changes the value displayed in the readout 7. Thus, the vertical position of the blade 1 may be adjusted according to the diameter of the blade 1 to obtain the desired depth of cut in material.

The blade 1 comprises a circumferential cutting edge 10 and a vertically-oriented planar surface 8 on which indicia 9 corresponding to a plurality of blade diameters is shown. It will be appreciated indicia 9 may not only be numerals, but also letters, pictograms, icons, or any other symbols that may indicate blade diameter. The values of the diameters range from a maximum equal to the diameter of a new blade 1, to a minimum equal to the lowest allowable diameter that can be used before the blade 1 is required to be replaced. Those skilled in the art will appreciate that continued use of the blade 1 dulls the circumferential cutting edge over time. If the circumferential cutting edge 10 is allowed to dull too much, the cut in the material may be imprecise at best and may be torn at worst. As a result, the circumferential cutting edge 10 is re-sharpened to hone the edge once again. However, honing the circumferential edge 10 reduces the diameter of the blade 1. This can create an error in the vertical position of the blade relative to the material to be cut. Therefore, the blade 1 must be adjusted vertically to position the blade 1 relative to the material in order to obtain the desired depth of cut.

After sharpening the blade 1, the diameter thereof is measured and that measurement is indicated on the blade surface 8, for example, by underlining or circling the measured diameter value. Accordingly, when setting the vertical position of the blade 1, the rotating adjustment knob 6 may be rotated until the same value is displayed in the readout 7, setting the proper vertical position of the blade 1. In one embodiment, the readout 7 is configured with a rotating drum on which is printed the values of the diameters comprising the indicia 9 on the planar surface 8 of the blade 1.

As described above and shown in the associated drawings, the present invention comprises a circular cutting blade having indicia corresponding to blade diameter and cutting assembly. While particular embodiments have been described, it will be understood, however, that any invention appertaining to the apparatus described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. A vertically adjustable cutting assembly comprising:
a circular cutting blade having a circumferential cutting edge defined by a diameter and a vertically-oriented planar surface, said planar surface having indicia corresponding to a plurality of said diameters.

2. The vertically adjustable cutting assembly of claim 1, wherein said indicia may comprise one of numerals, letters, pictograms and icons.

3. The vertically adjustable cutting assembly of claim 1, wherein values of said diameters range from a maximum value to a minimum value, said minimum value corresponding to a minimum allowable value.

4. The vertically adjustable cutting assembly of claim 3, further comprising a vertical adjustment assembly having a readout configured to display diameter values corresponding to the values of each of the plurality of diameters comprising said indicia.

5. A circular cutting blade comprising a circumferential cutting edge defined by a diameter and vertically-oriented planar surface that includes indicia thereon, said indicia comprising a plurality of symbols corresponding to a plurality of diameter values defining said circumferential cutting edge after honing thereof.

6. The circular cutting blade of claim 5, wherein said values of said diameters range from a maximum value to a minimum value, said minimum value corresponding to a minimum allowable value.

7. The circular cutting blade of claim 5, wherein said indicia may comprise one of numerals, letters, pictograms and icons.

8. A method for maintaining a circular cutting blade, said cutting blade having a circumferential cutting edge defined by a diameter and a planar surface comprising indicia corresponding to a plurality of diameter values, said method comprising the steps of:
sharpening said circumferential cutting edge;
after said step of sharpening, measuring blade diameter to obtain a measured diameter value; and
indicating an indicium of said indicia corresponding to said measured diameter value.

9. The method of claim 8, wherein said indicia may comprise one of numerals, letters, pictograms and icons.
